(19) United States
(12) Patent Application Publication
(10) Pub. No.: US 2006/0031927 A1
(43) Pub. Date: Feb. 9, 2006

(54) Information management system, information management method, and system control apparatus

(76) Inventors: Masahiro Mizuno, Campbell, CA (US); Kazunari Suzuki, Oakland, CA (US)

Correspondence Address: BIRCH STEWART KOLASCH & BIRCH, PO BOX 747, FALLS CHURCH, VA, 22040-0747, US

(21) Appl. No.: 09/917,683

(22) Filed: Jul. 31, 2001

Related U.S. Application Data
(60) Provisional application No. 60/227,025, filed on Aug. 23, 2000.

(51) Int. Cl. G06F 15/16

(52) U.S. Cl. 726/11

(57) ABSTRACT

[Problem] Information communication cannot be performed through a system with high-level security installing such as firewall, and it is not possible to construct an information management system which allows seamless access to information from inside/outside of an intranet.

[Means to Solve the Problem] A system control apparatus 60 is provided to an intranet 30 for managing groupware information and files. A service site 70 is provided to an Internet 10. A file duplication daemon 63c is provided to each of clients 40 and 41. The file duplication daemon 63c in cooperation with the system control apparatus 60 transfers data of the client 40 to disk resources 50, 61, 71 of the intranet or the Internet as a file. Further, the system control apparatus 60 in cooperation with the service site 70 synchronizes groupware information. Accordingly, seamless access to the information can be accomplished from both inside and outside of the intranet.

### DETAILED EXPLANATION OF THE INVENTION

1. Field of the Invention

The present invention relates to an information management system which can be preferably used for managing consistency of data and effectively transferring the data, especially, without reducing security performance of an intranet in an intranet-extranet configuration, in which the intranet has groupware function and file sharing function and the extranet is such as an Internet connected to the intranet via firewall.

2. Related Art

In order to safely share information with a high secrecy within a specific company, it is required to construct security system preventing an unauthorized access. For example, to prevent an unauthorized access to the company's intranet from outside, the company installs a gateway called a firewall at an entrance of each of the intranet.

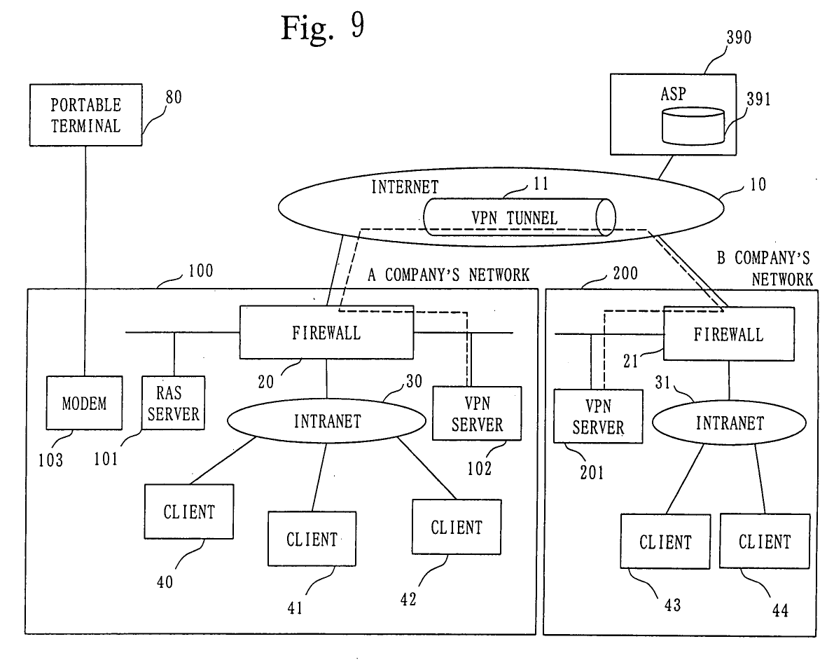

However, in this configuration, the firewall also prevents reference to information stored in groupware or a file to be shared within the intranet of the company. To deal with such a problem, technological solution shown in FIG. 9 has been conventionally used.

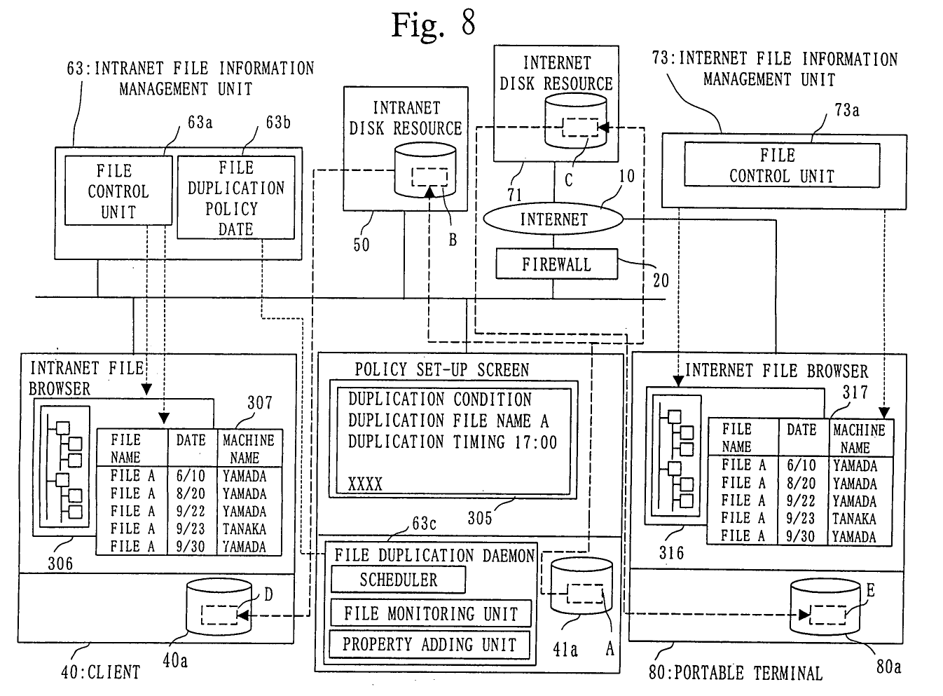

FIG. 8 shows a block diagram of a conventional system that allows intranet data to be accessed from the outside. In FIG. 9, a reference numeral 10 shows Internet, 100 shows A company's intranet, and 20 shows a firewall. Likewise, 31 shows B company's intranet, 21 shows a firewall that protects each company's intranet from penetration from the outside. 40 through 44 show clients.

In the configuration shown in the figure, however, the firewall 20 or 21 prevents communication between A company and B company such as exchanging information or files through the Internet 10. To solve such a problem, both companies employ VPN (virtual private network) connection. That is, a VPN server 102 is provided to the A company's intranet, and another VPN server 201, which is compatible with the VPN server of the A company, is provided to the B company's intranet. Security is thus ensured by transferring encrypted data through a VPN tunnel 11.

Further, a RAS (remote access server) 101 is installed at the firewall 20. The RAS allows an outside portable terminal 80 to dial-up to refer to information or files via a modem 103 connected to the RAS 101. By this configuration, data residing in the A company's intranet 100 can be accessed without passing the firewall.

As for another solution, an operation is outsourced to an outside ASP (application service provider) 390. All information and files that A company and B company want to share or to access from the outside are stored in a disk resource 391 of the ASP 390, managed, utilized and referred. By this configuration, the information and files can be accessed from anywhere through Internet.

Further, another method has been proposed, in which data of information or files is converted into electronic mail form and transferred between the intranets, as disclosed in Japanese Unexamined Patent Publication No. HEI 11-219326 “Electronic File Management System”, and Japanese Unexamined Patent Publication No. 2000-148611 “Intranet, Database Server and Data Transferring Method”.

However, in the above methods, it is required to provide a device for encrypting the information to all places that will access the information, which increases the cost, and further, the compatibility will be a problem among various kinds of devices for encrypting. Further, in case of providing a channel that goes without passing through the firewall, the security cannot be adequately ensured. In addition, in case of locating data outside, it takes time to access an outside recording medium, and a performance of the system might be lowered because of concentration of the load from the user. Further, different log-in procedures are required for various kinds of terminals, which causes the operation more complex. Since the data is located outside, it is difficult to secure secrecy of the data. Consequently, the conventional methods have not embodied a seamless access.

In the above conventional cases, the firewall 20 provided between the Internet 10 and the intranet 30 to protect the company's network, namely, the intranet 30, utilizes pop3 protocol (port number 110) for receiving a mail, smtp protocol (port number 25) for transmitting a mail, ftp protocol (port number 21) for transferring a file, and http protocol (port number 80) for retrieving Web information. Furthermore, the firewall 20 only allows to access data from the inside to the outside of the intranet except receiving/transmitting E-mail.

[Problems to be Solved by the Invention]

According to the conventional art, it is not possible to pass information or files utilized in the company through the network having a high security level with the firewall etc.

An object of the present invention is to obtain information management system which enables a seamless access, while the present security technologies are used.

[Means to Solve the Problem]

As a preferred embodiment of an information management system of the present invention, in a network system having an intranet secured by firewall and Internet communicating with the intranet via the firewall, the embodiment includes a system control apparatus which manages personal information, such as schedule belonging to each member of the intranet and files handled by the member, as master data.

The preferred embodiment of the information management system of the present invention has a service site, on the Internet, including a disk resource which can be accessed from the intranet and a function of storing the personal information and the files of the intranet in the disk resource as duplicate data.

According to the preferred embodiment of the information management system of the present invention, any changes of both of the personal information of the system control apparatus are monitored from the system control apparatus, and the embodiment further includes a personal information update daemon which manages the personal information of the service site and the personal information of the system control apparatus so that both of the personal information have the same contents.

The preferred embodiment of the information management system of the present invention includes a file duplication daemon in the client of the intranet, which duplicates master data of the client and transfer the duplicate data of the master data to an intranet disk resource or the service site disk resource in cooperation with the system control apparatus.

According to the preferred embodiment of the information management system of the present invention, timing for generating duplication of the master data by the file duplication daemon can be set by file duplication policy. Further, the embodiment includes a property adding unit which changes the file name and adds property information, such as time of storing the file, a client name instructing to store the file, when the duplicate data is generated.

The preferred embodiment of the information management system of the present invention includes an intranet file information management unit which accesses the system control apparatus from the intranet client through WWW browser, refers the duplicate data stored in the intranet disk resource by the file duplication daemon, and downloads the duplicate data to the client.

The preferred embodiment of the information management system of the present invention includes an Internet file information management unit which accesses the service site from the access terminal on the Internet through the WWW browser, refers to the duplicate data transferred from the intranet by the file duplication daemon and stored in the disk resource of the Internet, and downloads the duplicate data to the access terminal.

The preferred embodiment of the information management system of the present invention includes an intranet group information generation unit which generates group information of a group to which a member belongs on the system control apparatus using the personal information, and an Internet group information generation unit which generates the same group information on the service site.

The preferred embodiment of the information management system of the present invention has a function which allows the user to access the information on the service site from various kinds of access terminal connected to the Internet (a client, a home PC via service provider, a portable terminal, a cellphone and so on) with the same or similar user interface as the user interface provided by the client to the user, in addition, using the same password as the password which the user enters to the client.

### EMBODIMENT OF THE INVENTION

In the following, an embodiment of the present invention will be explained in detail in reference to the figures.

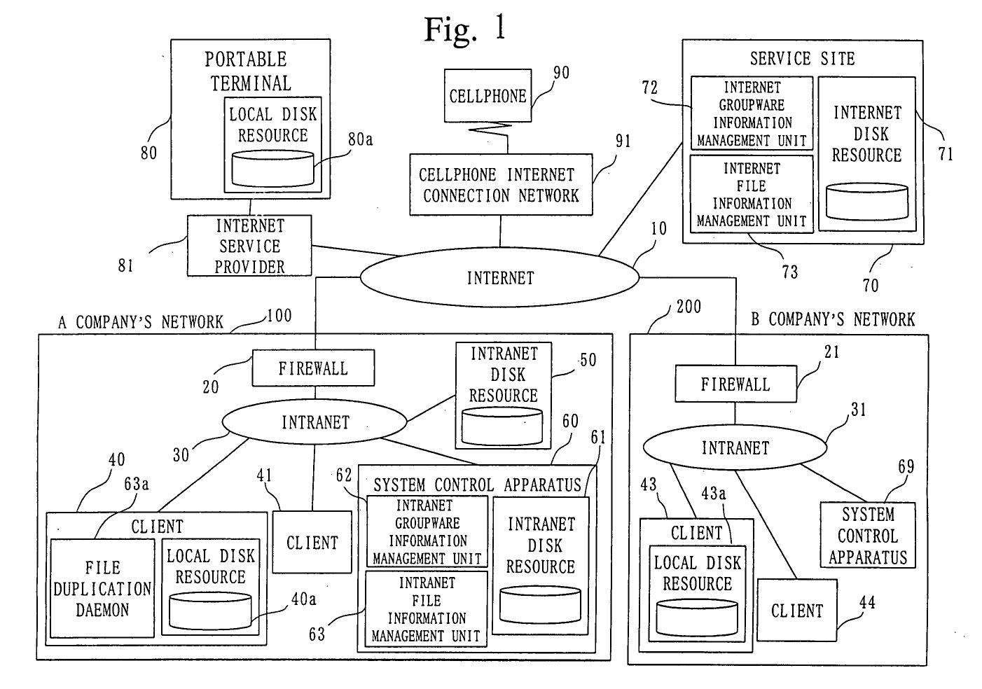

FIG. 1 is a block diagram showing a connection among intranets and other networks according to the present invention.

In FIG. 1, a reference numeral 10 shows Internet, 100 shows A company's network, and 200 shows B company's network. 80 denotes a portable terminal such as a note PC (personal computer), home PC, 81 denotes an Internet service provider for connecting the portable terminal 80 to the Internet via telephone line, 90 denotes a cellphone, and 91 denotes a cellphone Internet connection network for connecting the cellphone to the Internet. The A company's network 100 and the B company's network 200, and further, the portable terminal 80 and the cellphone 90 are respectively connected via the Internet 10 to form an extranet.

Within the A company's network 100, a reference numeral 20 shows a firewall, 30 shows an intranet, and 40, 41 show clients connected to the intranet 30. Likewise, within the B company's network 200, 21 shows a firewall, 31 shows an intranet, and 43, 44 show clients connected to the intranet 31. Each intranet's security is ensured by the firewall 20 or 21 that protects the network from attack from the outside.

In the A company's network 100, 50 shows an intranet disk resource to be shared amongst the clients in the intranet 30. 60 is a system control apparatus for managing groupware and files, and 61 is an intranet disk resource which locates inside of the system control apparatus 60 and is shared amongst the clients in the intranet in the same way as the intranet disk resource 50. 62 denotes an intranet groupware information management unit which manages groupware information such as schedule information, contact information of each user within the intranet 30, and 63 denotes an intranet file management unit which manages file information of the clients of the intranet 30. In the B company's network 200, 69 is a system control apparatus, which is the same as the system control apparatus 60.

Within the client 40, 40a denotes a local disk resource which stores data of the client 40, and 63c denotes a file duplication daemon which duplicates data of the local disk resource 40a and stores in the intranet disk resource 50 and the Internet disk resource 71.

Within the service site 70, 71 shows an Internet disk resource to be accessed by the A company's network 100, the B company's network 200, the portable terminal 80 and so on. 72 denotes an Internet groupware information management unit which manages groupware information such as schedule information, contact information of each user within the A company's network 100 and the B company's network 200 over the Internet, and 73 denotes an Internet file management unit which manages file information of the clients within the A company's network 100 and the B company's network 200 over the Internet.

Next, location and flow of each data relating the groupware will be outlined.

The groupware information is managed by the system control apparatus 60, and master data is located in the intranet disk resource 61. The intranet groupware information management unit 62 executes reference to the data, update of the data and so on. Similar data is managed by the Internet groupware information management unit 72, and the data is located in the Internet disk resource 71.

Next, location and flow of each data relating the files will be outlined.

Data of each client, for example, data of the client 40 is located in the local disk resource 40a. The file duplication daemon 63c duplicates and compresses the data of the local disk resource 40a, and the compressed duplicate data is transferred to the intranet disk resource 50, or the intranet disk resource 61, the Internet disk resource 71. The data transferred and stored in the intranet disk resource 61 can be further transferred to the client 41 through the intranet file information management 63. The client 41 thus can restore and use the transferred data.

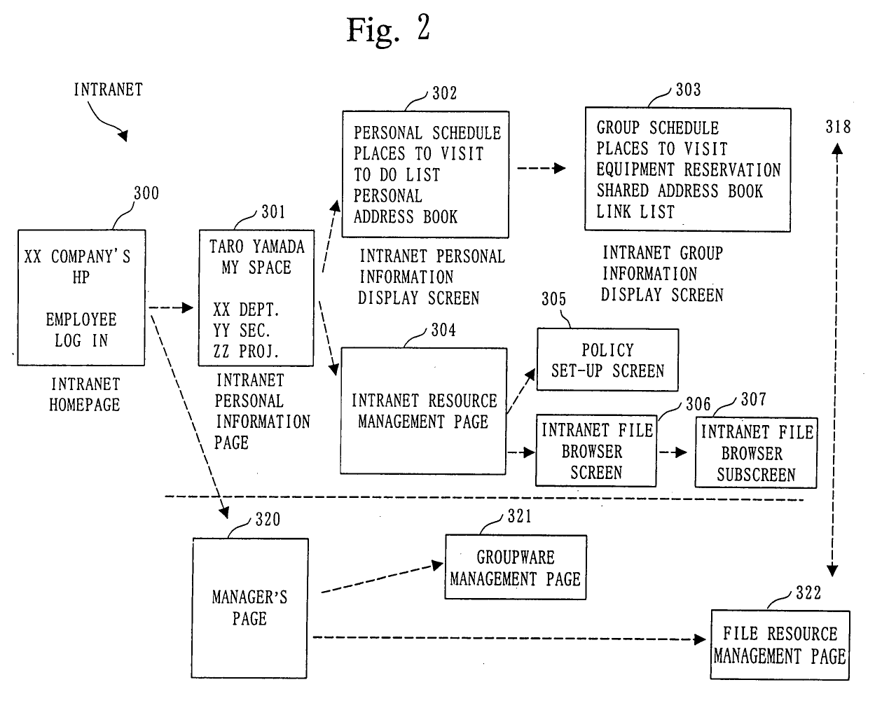

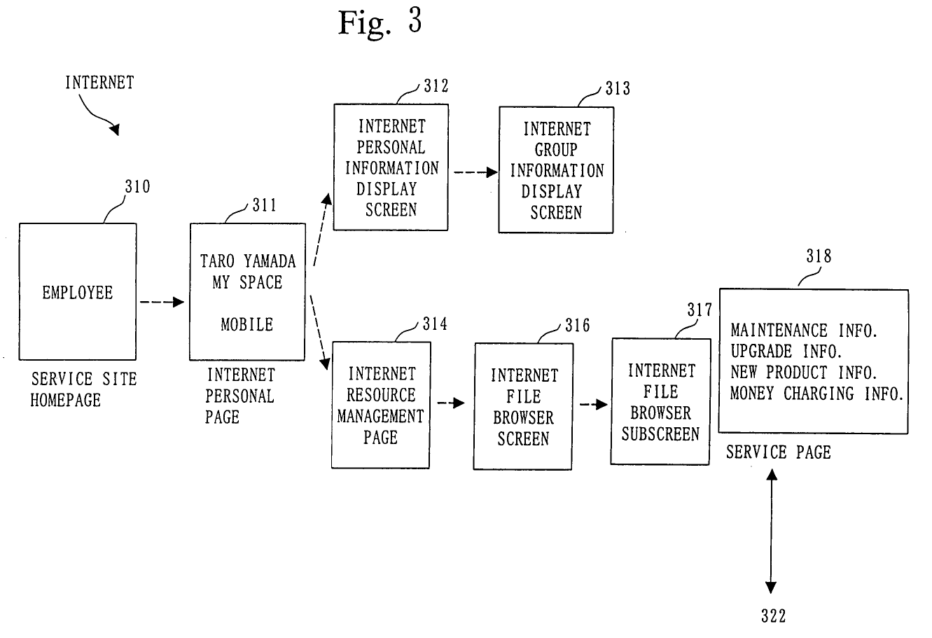

In the following, user interface will be explained in reference to FIGS. 2 and 3.

In FIGS. 2 and 3, each block shows a screen display.

300 shows an intranet homepage, through which each user enters. Contents are physically located in the system control apparatus 60, and each user can access the contents from an arbitrary client connected to the intranet 30 via a WWW browser. 301 shows an intranet personal information page personally assigned to each user. The intranet personal information page 301, which is managed for each user, can be accessed by entering a user ID and a password in the log-in screen of the intranet homepage 300.

302 shows a personal information display screen for accessing the groupware information of each user. The user can access the groupware information, including such as a message board, Places To Visit, reservation information of a meeting room, and check the information. 303 is a display screen of information merging plural pieces of information of all group members such as schedule of a group to which each user belongs. The user can access the screen and check the information. The display screens 302 and 303 are provided for displaying the groupware information generated and updated by the intranet groupware information management unit 62.

Further, 304 shows a resource management page for managing a disk resource of each user, 305 is a policy set-up screen which sets timing and condition for transferring to duplicate a file of the client 305 to the intranet disk resource 50, 61 or the Internet disk resource 71. 306 shows a file browser screen which displays and selects the duplicate file stored in the intranet disk resource 50, 61, or the Internet disk resource 71 and downloads to the client. 307 shows a file browser sub-screen which displays properties of each file displayed on the file browser screen 306 such as date when the file was created, version of the file, name of the client who edited the file. The screens 304, 305, 306, and 307 display the files or data managed by the intranet file information management unit 63.

In FIG. 2, 320 shows a manager's page for administrating the intranet, through which the following pages can be accessed by the manager.

321 shows a groupware management screen which registers a member of the groupware and managing information to be shared. 322 shows a file resource management screen which manages an operating status of each terminal of the intranet and the file duplication daemon 63c which operates at the terminal. The screen 321 is provided only to the manager by the intranet groupware information management unit 62. The screen 322 is provided only to the manager by the intranet file information management unit 63.

In FIG. 3, 310 shows a service site homepage which locates at the service site 70 of the Internet 10. The service site homepage can be accessed from an access terminal of the Internet. The user ID and password which are the same as the ones used for entering the client of the intranet should be entered to the service site. 311 shows an Internet personal page from which the personal information, corresponding to the intranet personal information page 301, can be accessed over the Internet.

312 shows a personal information display screen of the Internet, and 313 shows a group information display screen of the Internet. The screens 312 and 313 display groupware information generated and updated by the Internet groupware information management unit 72.

314 is an Internet resource management screen. 316 is a file browser screen which displays and selects the duplicate file stored in the Internet disk resource 71, and downloads the file to the portable terminal 80 etc. connected through the Internet. 317 shows a file browser subscreen which displays properties of each file displayed on the file browser screen 316 such as date when the file was created, version of the file, name of the client who edited the file. The screens 314, 316, 317, and 318 display the files or data managed by the intranet file information management unit 73.

In FIG. 3, 318 is a service page which locates in the service site 70 and provides maintenance information or upgrade information of the system control apparatus 60, the file duplication daemon 63c, and so on. The service page 318 also operates in accordance with the file resource management page 322 and manages money charging information for each service. The screen 318 is provided only to the manager by the service site 70.

In FIGS. 2 and 3, the following screens have the same or similar displays and the same or similar user interfaces:

The screens 300 and 310; the screens 301 and 311; the screens 302 and 312; the screens 303 and 313; the screens 304 and 314; the screens 306 and 316; and the screens 307 and 317. Therefore, the user can access the data having the same contents with the same or similar operation from both of the client and the access terminal.

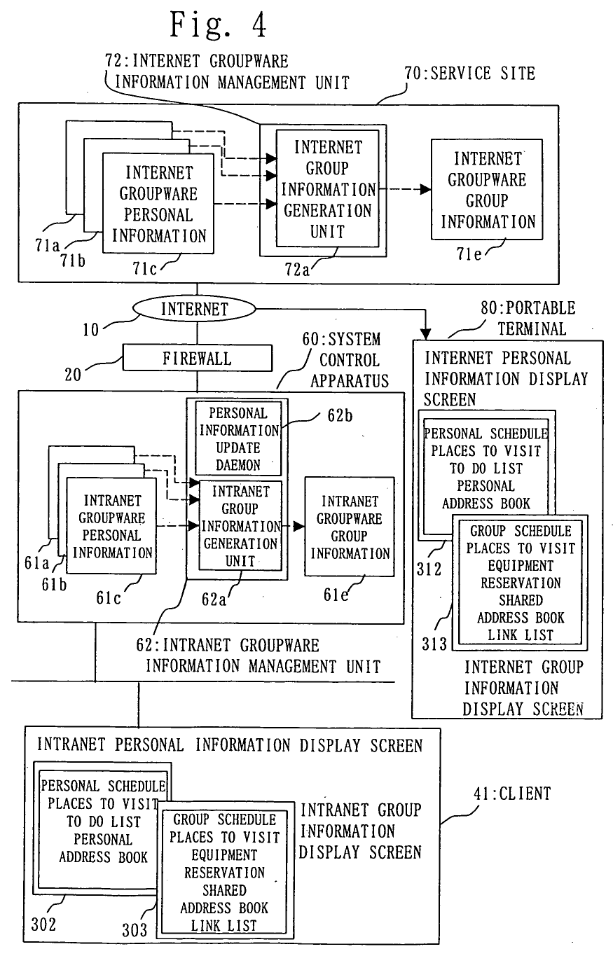

In the following, a detailed explanation will be made by referring to FIG. 4 concerning the display of the personal information and the group information of the system control apparatus 60 and the service site 70.

Each of 61a, 61b, and 61c is intranet groupware personal information showing the personal information of each user member stored in the intranet disk resource 61 of the system control apparatus 60. An intranet groupware group information 61e is generated by merging the intranet groupware personal information 61a, 61b, and 61c, and referred as information of the group which each user member belongs. An intranet group information generation unit 62a is a function within the Internet groupware information management unit 62 and generates the groupware group information 61e.

Each of 71a, 71b, and 71c is intranet groupware personal information showing the personal information of each user member stored in the intranet disk resource 71 of the service site 70. An Internet groupware group information 71e is generated by merging the Internet groupware personal information 71a, 71b, and 71c, and referred as information of the group which each user member belongs. An Internet group information generation unit 72a is a function within the Internet groupware information management unit 72 and generates the Internet groupware group information 71e.

Each user of the intranet accesses or updates information relating his business such as personal schedule, Places To Visit, To Do List, an address book using the intranet personal information display screen 302. This information is stored in the intranet groupware personal information 61a, 61b, 61c. The intranet group information display screen 303 displays the merged personal information by a group unit to which each user belongs and is used for confirming present locations of members, schedules of members of the same group and so on. The information has been recorded in the intranet groupware group information 61e.

On the other hand, the user, who accesses the information via the access terminal such as the portable terminal 80 of the Internet, accesses or updates the information relating to his business such as personal schedule, Places To Visit, To Do List, an address book, etc. using the Internet personal information display screen 312. The information is recorded in the Internet groupware personal information 71a, 71b, 71c. The Internet group information display screen 313 displays the merged personal information by a group unit to which each user belongs and is used for confirming the present locations of members, the schedules of members of the same group and so on. The information has been recorded in the Internet groupware group information 71e.

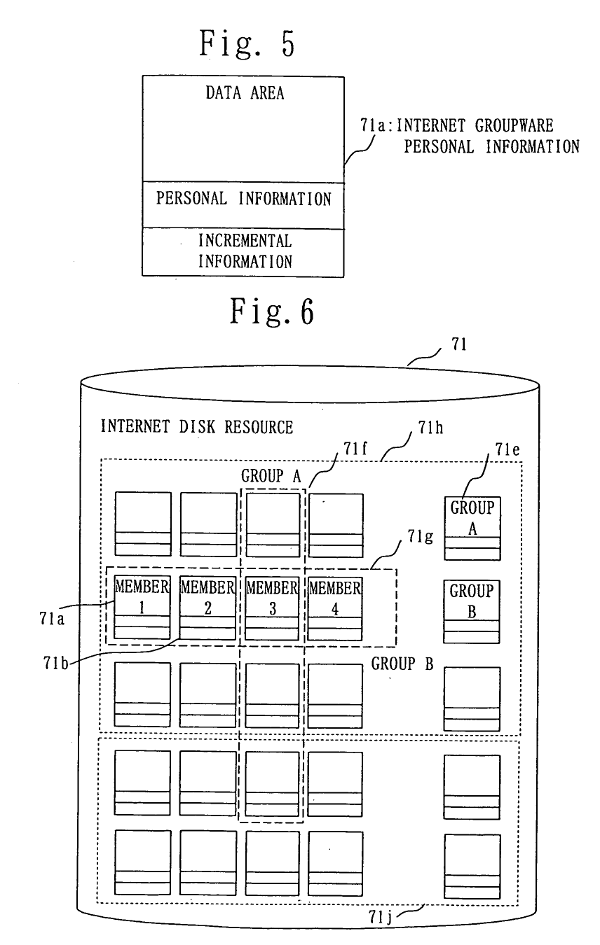

FIG. 5 shows an example of data structure in case of the Internet groupware personal information 71a. Other Internet groupware personal information 71b, 71c, as well as the intranet groupware personal information 61a, 61b, 61c have also the same structures, respectively. Within the groupware personal information, data area is provided, which can be used as a usual disk resource by each user. The groupware personal information further stores the personal information of the groupware by each user and, in addition, stores differential information of the modified contents entered by the client, the portable terminal, and so on via the personal information display screen, as incremental information.

Data location of the personal information within the system control apparatus 60 and the service site 70 will be explained in detail.

FIG. 6 illustrates data location within the Internet disk resource 71 of the service site 70.

The personal information data belonging to the intranet 30 such as 71a, 71b, 71c, etc. are located in an area 71h and constitute Group A 71f, Group B 71g. For example, in case of Group B 71g, one group consists of members 1 through 4 including the Internet groupware personal information 71a. A block 71e stores group information such as Groups A, B made of each personal information.

Within the intranet disk resource 61 of the system control apparatus 60 provided to the intranet 30, the intranet groupware personal information 61a, 61b, 61c are located in the same structure as shown in FIG. 6. The personal information of the system control apparatus 60 provided to the intranet 30 is located in an area 71h of the Internet disk resource 71. Similarly, the personal information of the system control apparatus 69 provided to the intranet 31 is located in an area 71j of the Internet disk resource 71. In this way, plural pieces of the intranet information are managed by one service site.

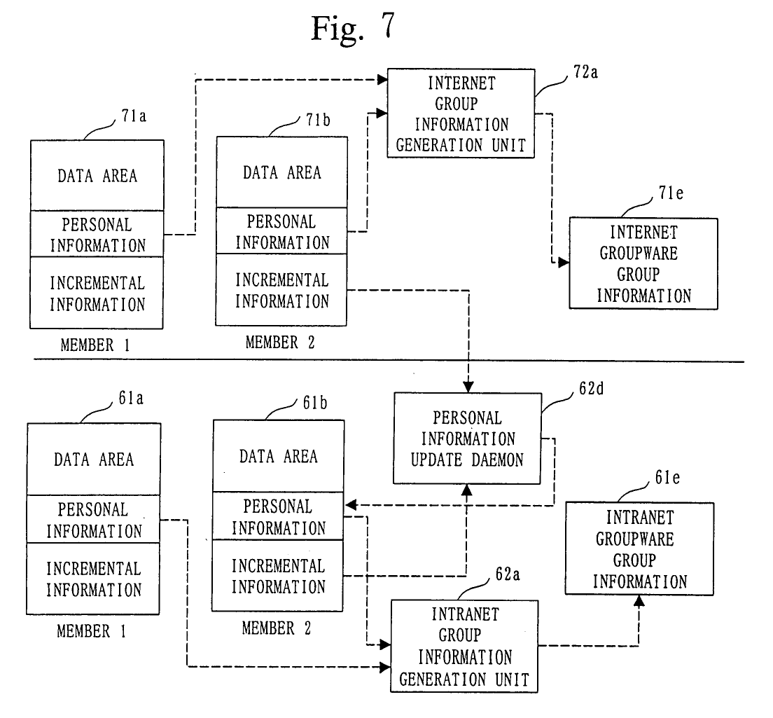

With reference to FIG. 7, a detailed explanation will be made concerning synchronization of the personal information of the system control apparatus 60 and the personal information of the service site 70.

Here, synchronization means to become the same data. That is, when one of the master data and the duplicate data is updated, the other is always updated so that both have the same contents.

In FIG. 7, the upper part of the figure shows data stored in the service site 70, and the lower part shows data stored in the system control apparatus 60. The figure shows the Internet group information generation unit 72a generates the Internet groupware group information 71e using the personal information stored in the Internet groupware personal information 71a, 71b. Similarly, the figure also shows the intranet group information generation unit 62a generates the Internet groupware group information 61e using the personal information stored in the intranet groupware personal information 61a, 61b.

When the personal information is modified within the Internet groupware personal information, for example, such as schedule is changed by the client or the portable terminal, the personal information is not directly modified, but the differential information is stored in the incremental information within each of the groupware personal information. The above process will be performed in the same way as in case of modifying the personal information within the intranet.

Here, modification includes generation of new groupware personal information. For example, if a new member n is added, new storing area is reserved for the intranet groupware personal information 61n for the new member n, and contents to be stored is recorded as the differential information in the incremental information of the groupware personal information.

62d shows a personal information update daemon located in the system control apparatus 60. The personal information update daemon monitors the incremental information, and if a certain update occurs, updates the personal information of the system control apparatus 60, which is the intranet groupware personal information 61b in the figure.

Then, the personal information update daemon transfers the intranet groupware personal information, which is the personal information 61b, to the service site 70 to write in the Internet groupware personal information, which is the personal information 71b in the figure.

On the other hand, the personal information update daemon 62d monitors the incremental information on the Internet groupware personal information 71b, and if a certain update occurs, updates the personal information of the Internet groupware personal information 71b. The personal information update daemon 62d also updates the personal information of the intranet groupware personal information 61b. When a new member is added, the personal information is updated in the same way as the update .

As described above, the synchronization has been successfully performed between the groupware personal information of the service site 70 and the system control apparatus 60 without any conflict which might be caused by an update request from the client of the intranet and an update request form the portable terminal and so on of the Internet.

A detailed explanation will be made below concerning the data duplication of the client referring to FIG. 8.

The user inputs the file duplication condition from the policy set-up screen 305 provided by the intranet information management unit 63. For example of the file duplication condition, the condition shown in FIG. 8 specifies to duplicate a file A ‘at 17:00 everyday’ as a duplication timing. This file duplication condition is recorded in the intranet information management unit 63 as file duplication policy data 63b. The file duplication daemon 63c duplicates the data of the local disk resource 40a based on the file duplication policy data 63b. In FIG. 8, a scheduler 63ca performs duplication of the data A of the client 41 at the time (17:00) specified by the duplication timing of the file duplication policy data to generate data B and data C. In another case, if the duplication timing is specified as ‘at updating time of the file’, a file monitoring unit 63cb monitors the file and detects the update of the file, and then the file monitoring unit 63cb duplicates the file. Here, the duplication does not mean to copy all data of the file A. Data consisting of writing data written onto the file A and properties such as date, version, name of the client machine added by the property adding unit 63cc to the writing data is transferred to the intranet disk resource 50 and the Internet disk resource 71 to be stored therein as the data B and the data C, respectively. Namely, the data B and the data C are difference data with the properties added.

If the file A is newly generated, the whole contents of the file A become the difference data.

The property adding unit 63cc adds, for example, the following:
Modified file name, if the file name is modified;
Time when the file is stored;
Version of the stored file;
Name of the client machine that instructs to store the file;
Date of update/written data;
Version of the update/written data; and
Name of the client machine that updates/writes data.

A detailed explanation will be given concerning restoration of the data performed by file control units 63a and 73a at the client 40 and the portable terminal 80 in reference to FIG. 8.

Each user member can select a necessary file by the file browser screens 306, 316, and further, the user can download the necessary file by selecting the file with the date, version, name of the client machine, etc. added as the properties from the files selected from the past history by the file browser subscreens 307, 317. The data B and the data C are incremental data to which the properties are added, and the file A can be generated at the client 40 or the portable terminal 80 using the incremental data. In another way, by composing the incremental data with the data of the file A stored in the client 40 or the portable terminal 80, the updated file A can be restored. The figure shows a case in which the client 40 downloads the data B into the local disk resource of the client 40 as data D. The figure also shows a case the data C of the Internet disk resource 71 is downloaded into the local disk resource 80a of the portable terminal 80 as data E.

In addition, the client 40 can download the data C into the local disk resource of the client 40 as data D. However, the portable terminal 80 cannot download the data B into the local disk resource 80a as data E since the firewall 20 is provided.

The premise of the present embodiment is that the data of the service site (server) of the Internet can be accessed only from the intranet side to the outside, and cannot be accessed from the Internet to the inside of the intranet because the firewall is installed in the system. Even if the user is under the environment in which the user cannot access the intranet, the present embodiment provides the user with the same status that the user accesses the intranet. The embodiment duplicates the master data of the intranet, and the duplicate data is transferred to the service site of the Internet. Consequently, the master data is inside of the intranet, while the duplicate data is on the Internet. If the user cannot access the master data of the intranet, the user accesses the duplicate data prepared on the Internet. Therefore, the present embodiment can provide the user with the exact same status that the user accesses the intranet even if the user is under the environment in which the user cannot access the intranet.

Further, when the duplicate data is updated, the duplicate data on the Internet is also updated by the information update daemon of the intranet. On the contrary, when the duplicate data on the Internet is updated, the master data is also updated by the information update daemon of the intranet. Using only access from the inside of the intranet to the outside, the information update daemon monitors update of data and updates data. Accordingly, the information update daemon can perform necessary operation even if the access from the Internet side to the inside of the intranet is prohibited.

Further, when the file duplication daemon transfers the file from the intranet to the Internet, the file duplication daemon performs the file transfer using only access from the inside of the intranet to the outside. Accordingly, the file duplication daemon performs a necessary operation even if the access from the Internet side to the inside of the intranet is prohibited.

Yet further, according to the present embodiment, the operation is performed without using the protocol for transmitting/receiving mail, so that the operation is not limited by the protocol for transmitting/receiving mail.

The personal information or files can be product database or E-mail and so on instead of the groupware. The file to be transferred can be the incremental data from the previous transmission. Further, the file transfer can be combined with another operation such as virus check. The present embodiment can be used for synchronizing the data between the databases of multiple intranet environments by referring to the transferred data on the Internet from another intranet.

Further, the above-described units or daemons can be implemented by software program. In case of implementing the above units or daemons as a program, the program should be stored in the memory such as the disk resource, and the stored program is read from the memory by CPU (central processing unit) of the client computer, the system control apparatus, or the service site (server) computer and executed. Further, a magnetic disk, an optical disk, or other kinds of disk drive can be used for the disk resource. The disk resource can be replaced by other nonvolatile storage (memory).

As has been described, according to the present embodiment, without any change to the intranet environment having the firewall for protection from the outside, only necessary data is located in the service site by protecting passwords, etc. on the Internet, and the information can be accessed freely by the access terminal such as the client, the dial-up portable terminal, the cellphone of another network connected to the Internet.

For example, it is assumed that Mr. Yamada, an employee of the A company, is allowed to access the file of the local disk resource 40a, the intranet groupware personal information 61a, and intranet groupware group information 61e by the client 40 placed inside of the company using a password ‘XYZ’. In this case, Mr. Yamada also can access the duplicate data, having the same contents as the master data which he accesses inside of the company, from outside of the company by accessing the file of the Internet disk resource 71 of the service site 70, the Internet groupware personal information 71a, and the Internet groupware group information 71e from the portable terminal 80 such as note PC using the same password ‘XYZ’.

Further, according to the present embodiment, one system control apparatus can manage the information of the groupware and the file to be accessed by each member at the same time. In addition, since the properties are added to the duplicate data by the property adding unit, it is possible to refer to the information of the past file or the file modified by another environment by backdating such information.

Further, according to the present embodiment, the master data is always secured in the intranet. The transfer of the data is always initiated by the system control apparatus, the client of the intranet, or the access terminal, so that the load caused by the transfer operation of the data is distributed. That is, the load is not concentrated on the server of the service site, which prevents the reduction of the response necessary to the essential operation. In addition, plural system control apparatuses can be cooperated via the service site, which ensures the scalability according to the scale of the system.

Yet further, according to the present embodiment, each file is duplicated and distributed to the disk resource of the intranet or the Internet, and furthermore, the master file is always stored in the intranet. Therefore, the security of the file can be increased, and at the same time, the accessibility of the file can be ensured against the network failure of the outside of the company.

### BRIEF EXPLANATION OF THE DRAWINGS

[FIG. 1] FIG. 1 is a block diagram showing a whole system of an embodiment according to the present invention.

[FIG. 2] FIG. 2 is a block diagram showing user interface within the intranet shown in FIG. 1.

[FIG. 3] FIG. 3 is a block diagram showing user interface within the Internet shown in FIG. 1.

[FIG. 4] FIG. 4 is a block diagram showing an operation of the groupware information management unit shown in FIG. 1.

[FIG. 5] FIG. 5 shows a format of the data block shown in FIG. 4.

[FIG. 6] FIG. 6 is a block diagram showing data location of the disk resource shown in FIG. 1.

[FIG. 7] FIG. 7 is a block diagram showing process of the data block shown in FIG. 6.

[FIG. 8] FIG. 8 is a block diagram showing data operation of the file information management unit shown in FIG. 1.

[FIG. 9] FIG. 9 is a block diagram showing a conventional system.

[Explanation of Signs]

10 Internet, 20 firewall, 21 firewall, 30 A company's intranet, 31 B company's intranet, 40 client, 41-44 clients, 60 system control apparatus, 61 intranet disk resource, 62 intranet groupware information management unit, 63 intranet file information management unit, 70 service site, 71 Internet disk resource, 72 Internet groupware information management unit, 73 Internet file information management unit, 80 portable terminal, 81 Internet service provider, 90 cellphone, 91 cellphone Internet connection network, 100 A company's network, 200 B company's network.

What is claimed is:

1. Information management system for a network system, the network system having Internet connecting an access terminal and an intranet connected to the Internet via firewall and connecting a client, the information management system comprising:
a system control apparatus, connected to the intranet, for storing data to be accessed by the client connected to the intranet as master data, and transferring the master data from the intranet to the Internet; and
a service site, connected to the Internet, for receiving the data transferred from the system control apparatus, storing the data received as duplicate data of the master data; and for allowing the access terminal connected to the Internet to access the duplicate data stored.

2. The information management system of claim 1 further comprising an information update daemon for monitoring an update of the master data by the client, updating the duplicate data of the service site in a same way as updating the master data, monitoring an update of the duplicate data by the access terminal, and updating the master data of the system control apparatus in a same way as updating the duplicate data.

3. The information management system of claim 1, wherein
the system control apparatus includes an intranet groupware information management unit for storing plural pieces of personal information as the master data, and generating group information using the plural pieces of personal information; and
the service site includes an Internet groupware information management unit for receiving the plural pieces of personal information, storing the plural pieces of personal information received as the duplicate data, and generating group information using the plural pieces of personal information.

4. The information management system of claim 1 further comprising a file duplication daemon, operated in the client, for transferring data from the client to the service site, and
wherein the system control apparatus stores condition for transferring the duplicate data to the service site as a file duplication policy and instructs the file duplication daemon to transfer a file belonging to the client to the service site based on the file duplication policy.

5. The information management system of claim 4, wherein the system control apparatus includes a file control unit for making the access terminal or the client select the duplicate data of the service site and downloading the duplicate data of the service site selected to the access terminal or the client.

6. An information management method for a network system, the network system having Internet connecting an access terminal and an intranet connected to the Internet via firewall and connecting a client, the information management method comprising:
a system controlling step for storing data to be accessed by the client connected to the intranet as master data and transferring the master data from the intranet to the Internet; and
a service site step for receiving the data transferred by the system controlling step, storing the data received as duplicate data of the master data, and for allowing the access terminal connected to the Internet to access the duplicate data stored.

7. A system control apparatus connected to an intranet of a network system, the network system having Internet connecting an access terminal, a service site connected to the Internet and storing data and allowing the access terminal connected to the Internet to access the data stored and the intranet connected to the Internet via firewall and connecting a client, the system control apparatus comprising:
a memory for storing data to be accessed by the client connected to the intranet as master data;
an information management unit for transferring the master data from the intranet to the service site of the Internet, and making the service site store the master data transferred as duplicate data; and
an information update daemon for monitoring an update of the master data by the client, updating the duplicate data of the service site in a same way as updating the master data, monitoring an update of the duplicate data by the access terminal, and updating the master data of the system control apparatus in a same way as updating the duplicate data.

8. The information management system of claim 1, wherein the service site temporarily stores master data required to access as duplicate data by duplicating the master data from the system control unit when the service site receives a request to access data by the access terminal, and the service site deletes the duplicate data after the request to access data by the access terminal is resolved.

9. The information management system of claim 1,
wherein the service site transfers an input/output command for the master data generated by the access terminal to the system control unit, and
wherein the system control unit executes the input/output command transferred from the service site for the master data.
